(19) United States
(12) Patent Application Publication
(10) Pub. No.: US 2026/0308942 A1
(43) Pub. Date: Oct. 8, 2026

(54) SECURITY ASSEMBLY FOR SECURE DISPLAY OF A SMART WATCH DEVICE IN A RETAIL SETTING

(71) Applicant: Scorpion Security Products, Inc., Vestal, NY (US)

(72) Inventors: Adam Bixby, Endicott, NY (US); Franklyn W. Gulick, JR., Binghamton, NY (US); Grant William Gulick, Endwell, NY (US); Gary Page, Chenango Forks, NY (US)

(73) Assignee: Scorpion Security Products, Inc., Vestal, NY (US)

(21) Appl. No.: 19/641,168

(22) Filed: Apr. 7, 2026

Related U.S. Application Data
(60) Provisional application No. 63/785,144, filed on Apr. 8, 2025.

(51) Int. Cl. E05B 73/00; F16M 13/02

(52) U.S. Cl. CPC E05B 73/0082; F16M 13/02

(57) ABSTRACT

A security assembly for secure display of an item of merchandise includes a base body including a top surface, a bottom surface, and a plurality of side surfaces, wherein a plurality of pockets are defined in the plurality of side surfaces. A rim is movably coupled to, and at least partially surrounding, the base body. The rim defines a plurality of locking seats positioned adjacent to each of the plurality of pockets. A base support is configured to move between an open and closed position and a retainer is configured to removably couple to the base portion. When in the open position, the retainer is removable from the base body and when in the closed position, the retainer is configured to cooperate with one of the plurality of locking seats and one of the plurality of pockets to inhibit separation of the retainer from the base portion

### CROSS-REFERENCE TO RELATED APPLICATION

This application claims priority to, and the benefit of, U.S. Provisional Patent Application Ser. No. 63/785,144, filed on Apr. 8, 2025. The entire contents of said application are herein incorporated by reference.

### TECHNOLOGICAL FIELD

The following disclosure is directed to embodiments of a security assembly for merchandise for display in a retail setting, and specifically to a security assembly for display of watches and other electronic devices in a retail setting.

### BACKGROUND

Electronic devices are displayed for the public during the hours of operation, then removed from the display to be secured overnight or after hours. Removing all these devices from secure display at the end of each day and then resetting them for secure display at the beginning of each day requires considerable time and employee interaction with the security devices. In some situations, the employees may require special training to install and uninstall the security devices onto the electronic devices without damaging the electronic devices.

These are just some of the problems associated with the security devices currently used to secure electronic devices, such as watches, for secure display in a retail setting.

### BRIEF SUMMERY OF THE INVENTION

Aspects of the disclosure are directed to embodiments of a security assembly for secure display of an item of merchandise in a retail setting. In some embodiments, the security assembly includes a base portion including a base body including a top surface, a bottom surface, and a plurality of side sur-faces, wherein at least two of the plurality of side surfaces define a plurality of pockets. In some embodiments, the security assembly includes a rim movably coupled to, and at least partially surrounding, the base body, wherein the rim defines a plurality of locking seats positioned adjacent to each of the plurality of pockets. In some embodiments, the security assembly includes a base support configured to move between an open and closed position and a retainer configured to removably coupled to the base portion. In some embodiments, the retainer includes a plurality of retainer supports each extending from a first end to a second end and a retainer frame that is coupled to each second end of the plurality of retainer supports and defining an opening positioned over the top surface of the base body when the retainer is couped to the base portion. In some embodiments, when the security assembly is in the open position, the retainer is removable from the base portion. In some embodiments, when the security assembly is in the closed position, the first end of each of the plurality of base supports is configured to cooperate with one of the plurality of locking seats and one of the plurality of pockets to inhibit separation of the retainer from the base portion.

In some embodiments of the security assembly, when in the open position, the plurality of side surfaces of the base body are positioned above the rim, and when in the closed position, the plurality of side surfaces are positioned below the rim such that the rim inhibits movement of the first end relative to the one of the plurality of locking seats and the one of the plurality of pockets. In some embodiments of the security assembly, the base support includes a first support portion and a second support portion that are configured to be moved relative to each other to move the base body relative to the rim. In some embodiments of the security assembly, the plurality of retainer supports and the retainer frame are formed as a single unitary component. In some embodiments of the security assembly, the first end of each of the plurality of retainer supports includes a locking structure including a notch defined by a seat contact portion and an upper lip. In some embodiments of the security assembly, when in the closed position, the seat contact portion is configured to cooperate with one of the plurality of locking seats and one of the plurality of pockets and the notch is dimensioned to receive a portion of the base body. In some embodiments of the security assembly, the base portion includes a support structure positioned on the top surface of the base body and configured to aid in proper positioning of the item of merchandise to be secured between the base portion and the retainer.

Aspects of the disclosure are directed to embodiments of a security assembly for secure display an item of merchandise in a retail setting. In some embodiments, the security assembly includes a base body including a top surface, a bottom surface, and a plurality of side surfaces, wherein a plurality of pockets are defined in the plurality of side surfaces. In some embodiments, the security assembly includes a rim movably coupled to, and at least partially surrounding, the base body, wherein the rim defines a plurality of locking seats positioned adjacent to each of the plurality of pocket. In some embodiments, the security assembly includes a base support configured to move between an open and closed position and a retainer configured to removably coupled to the base portion. In some embodiments, when the security assembly is in the open position, the retainer is removable from the base body. In some embodiments, when the security assembly is in the closed position, the retainer is configured to cooperate with one of the plurality of locking seats and one of the plurality of pockets to inhibit separation of the retainer from the base portion.

In some embodiments, when the security assembly is in the open position, the plurality of side sur-faces of the base body are positioned above the rim and when the security assembly is in the closed position, the plurality of side surfaces are positioned below the rim such that the rim inhibits movement of the retainer relative to the one of the plurality of locking seats and the one of the plurality of pockets. In some embodiments, the security assembly further includes a base support that comprises a first support portion and a second support portion that are configured to be moved relative to each other to move the base body relative to the rim. In some embodiments of the security assembly, the retainer includes a plurality of locking structures that each include a notch defined by a seat contact portion and an upper lip. In some embodiments, when the security assembly is in the closed position, the seat contact portion is configured to cooperate with one of the plurality of locking seats and one of the plurality of pockets and the notch is dimensioned to receive a portion of the base body. In some embodiments, when the security assembly is in the open position, the seat contact portion of each locking structure is configured to move within the one of the plurality of locking seats and out of the one of the plurality of pockets to enable separation of the retainer from the base portion. In some embodiments of the security assembly, the base body includes a support structure positioned on the top surface of the base body and configured to aid in proper positioning of the item of merchandise for securing between the base portion and the retainer.

Aspects of the disclosure are directed to embodiments of a method of manufacturing a security assembly for secure display of an item of merchandise in a retail setting. In some embodiments, the method includes structuring a base portion to include a base body including a top surface, a bottom surface, and a plurality of side sur-faces that define a plurality of pockets. In some embodiments, the method includes structuring the base portion to include a rim at least partially surrounding the base body and defining a plurality of locking seats positioned adjacent to each of the plurality of pockets. In some embodiments, the method includes structuring the base portion to include a base support configured to move between an open and closed position. In some embodiments, the method includes structuring a retainer to removably couple to the base portion and structuring the retainer to cooperate with one of the plurality of locking seats and one of the plurality of pockets to inhibit separation of the retainer from the base portion when in the closed position.

In some embodiments, the method further includes structuring the plurality of side surfaces of the base body to be positioned above the rim when in the open position, and structuring at least a portion of the plurality of side surfaces to be positioned below the rim when in the closed position, such that the rim inhibits movement of the retainer relative to the one of the plurality of locking seats and the one of the plurality of pockets. In some embodiments, the method further includes structuring the base support to comprises a first support portion and a second support portion that are configured to be moved relative to each other to move the base body relative to the rim. In some embodiments, the method further includes structuring the retainer to include a plurality of locking structures that each comprise a notch defined by a seat contact portion and an up-per lip. In some embodiments, the method further includes structuring each seat contact portion to move within the one of the plurality of locking seats and out of the one of the plurality of pockets to enable separation of the retainer from the base portion when in the open position. In some embodiments, the method further includes structuring the seat contact portion to cooperate with one of the plurality of locking seats and one of the plurality of pockets and dimensioning the notch to receive a portion of the base body when in the closed position.

### BRIEF DESCRIPTION OF DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings.

FIG. 1A illustrates a top perspective view of an embodiment of a security assembly in a closed position, according to embodiments of the disclosure.

FIG. 1B illustrates a top perspective view of another embodiment of a security assembly in a closed position, according to embodiments of the disclosure

FIG. 2A illustrates a side plan view of the embodiment of FIG. 1A, according to embodiments of the disclosure.

FIG. 2B illustrates a side plan view of the embodiment of FIG. 1B, according to embodiments of the disclosure.

FIG. 3A illustrates a top plan view of the embodiment of FIGS. 1A and 2A, according to embodiments of the disclosure.

FIG. 3B illustrates a top plan view of the embodiment of FIGS. 1B and 2B, according to embodiments of the disclosure.

FIG. 4A illustrates a side plan view of an embodiment of the security assembly in an open position, according to embodiments of the disclosure.

FIG. 4B illustrates a side plan view of another embodiment of the security assembly in an open position, according to embodiments of the disclosure.

FIG. 5A illustrates a top plan view of the embodiment of FIG. 4A, according to embodiments of the disclosure.

FIG. 5B illustrates a top plan view of the embodiment of FIG. 4B, according to embodiments of the disclosure.

FIG. 6A illustrates a top plan view of an embodiment of the security device in the open position according to embodiments of the disclosure.

FIG. 6B illustrates a top plan view of another embodiment of the security device in the open position, according to embodiments of the disclosure.

FIG. 7 illustrates a side perspective view of an embodiment of the security device with an embodiment of a retainer removed from an embodiment of a base, according to embodiments of the disclosure.

FIG. 8 illustrates a side perspective view of an embodiment of the security device with an embodiment of a retainer removed from an embodiment of a base, according to embodiments of the disclosure.

FIG. 9 illustrates an exploded view of an embodiment of the security device, according to embodiments of the disclosure.

FIG. 10 illustrates a side view of an embodiment of the security device with the lock member in the open position, according to embodiments of the disclosure.

FIG. 11 illustrates a side view of an embodiment of the security device with the lock member in the closed position, according to embodiments of the disclosure.

### DETAILED DESCRIPTION

The following discussion relates to various embodiments of a security assembly for secure display of an electronic device, such as a watch. It will be understood that the herein described versions are examples that embody certain inventive concepts as detailed herein. To that end, other variations and modifications will be readily apparent to those of sufficient skill. In addition, certain terms are used throughout this discussion in order to provide a suitable frame of reference with regard to the accompanying drawings. These terms such as “upper”, “lower”, “forward”, “rearward”, “interior”, “exterior”, “front”, “back”, “top”, “bottom”, “inner”, “outer”, “first”, “second”, and the like are not intended to limit these concepts, except where so specifically indicated. The terms “about” or “approximately” as used herein may refer to a range of 80%-125% of the claimed or disclosed value. With regard to the drawings, their purpose is to depict salient features of the security assembly for secure display of an electronic device, such as a watch, and are not specifically provided to scale.

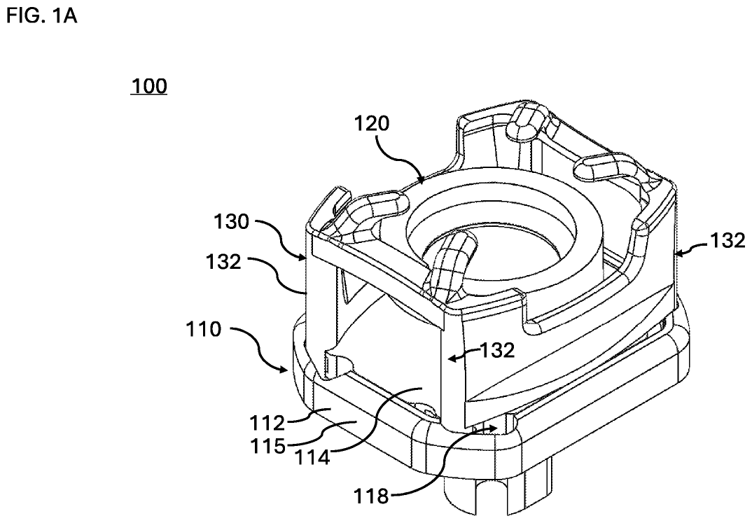

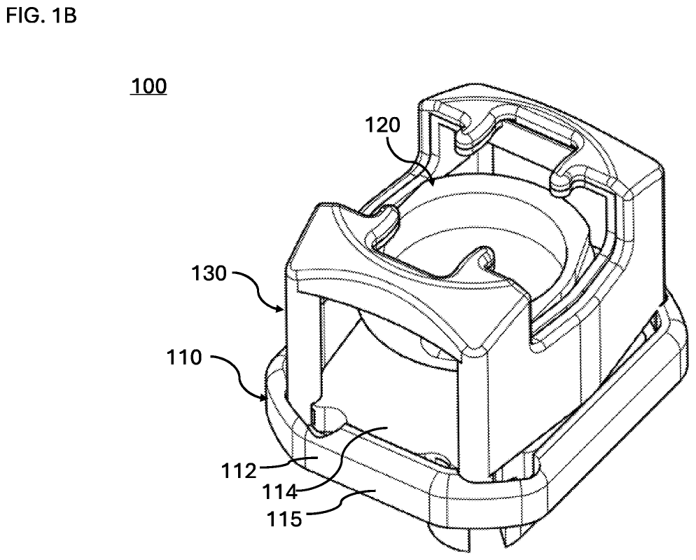

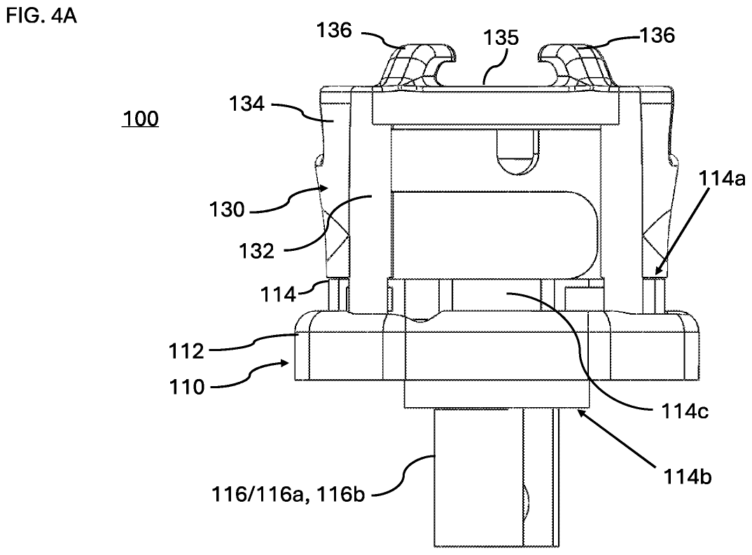

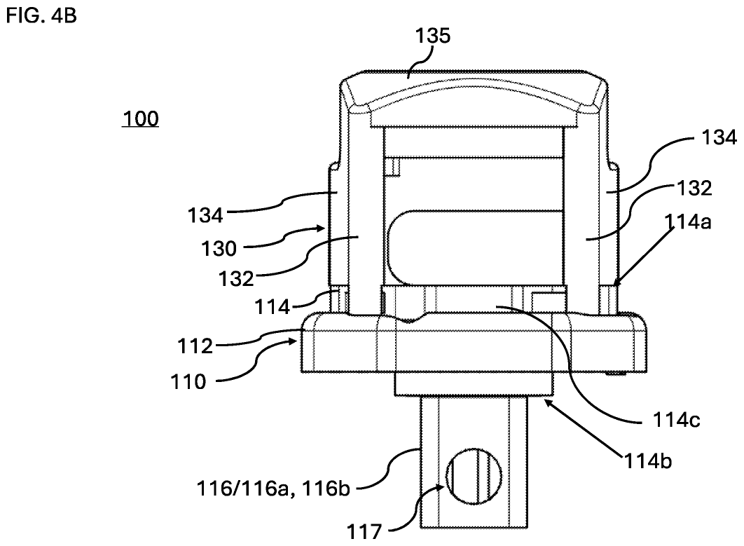

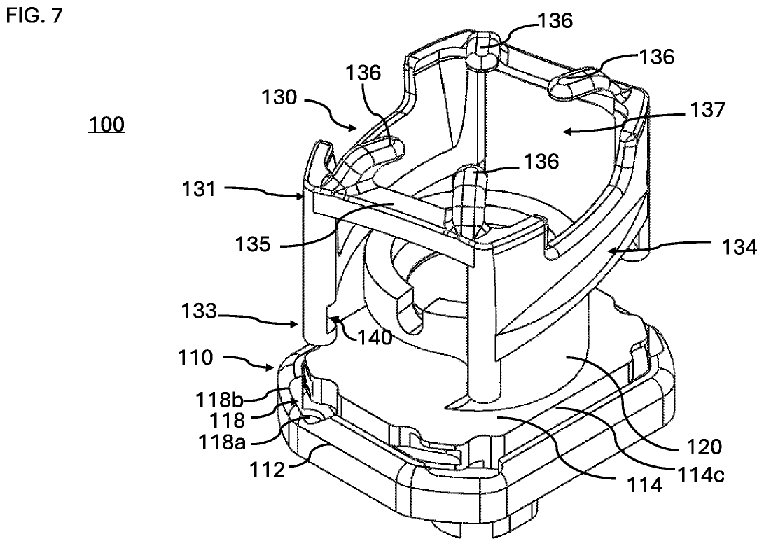

Referring to FIGS. 1A-8, some embodiments of a security assembly 100 for secure display of an electronic device, such as a watch or smart watch, include a base 110 and a retainer 130 that is removably coupled to the base 110. In some embodiments, the base 110 includes a rim 112, a support body 114 having an upper surface or a top surface 114a configured to receive or support the portable electronic device, and a base support 116 configured to extend from the bottom surface 114b of the support body 114. In some embodiments, the base body 114 further includes a plurality of side surfaces 114c defined between the top surface 104a and the bottom surface 114b. In some embodiments, the rim 112 at least partially surrounds the support body 114 and the base support is configured to move the rim 112 relative to the support body114 to define an open position (as shown in FIGS. 1A-3B) and a closed position (FIGS. 4A-6B). In some embodiments, the rim 112 defines an inner perimeter 113 and an outer perimeter 115. In some embodiments, a plurality of seats or locking seats 118 (FIGS. 1A, 1B and 7) are positioned or defined between the outer perimeter 115 of the rim 112 and the support body 114. In some embodiments, each of the plurality of locking seats 118 includes a first portion 118a and a second portion 118b. In some embodiments, the support body 114 defines a pocket 119 in one or more of the plurality of side surfaces 114c or between a bottom surface 114b of the support body 114 and the top surface 114a of the support body 114. In some embodiments, the support body 114 defines a pocket 119 in at least two of the plurality of side surfaces 114c. In some embodiments, the support body 114 includes a positioning structure or a support structure 120 positioned on the upper surface 114a and configured to receive or otherwise position the electronic device for display and for proper securing by the retainer 130. In some embodiments, the support structure 120 includes a wireless charger so that the electronic device may charge while being securely displayed.

In some embodiments, the base support 116 includes a plurality of support portions that move relative to each other in order to move the rim 112 relative to support body 114. In some embodiments, the plurality of support portions include a first support portion 116a and a second support portion 116b. In some embodiments, the plurality of support portions 116a, 116b are configured to slide in a telescopic manner relative to each other to extend and retract the support body 114. In some embodiments, the open position of the security assembly 100 is reached when the plurality of support portions 116a, 116b are extended, and the closed position is reached when the plurality of support portions 116a, 116b are retracted. In some embodiments, movement of the base support 116 between the extended and retracted positions may move the top surface 114a above and below the rim 112, respectively.

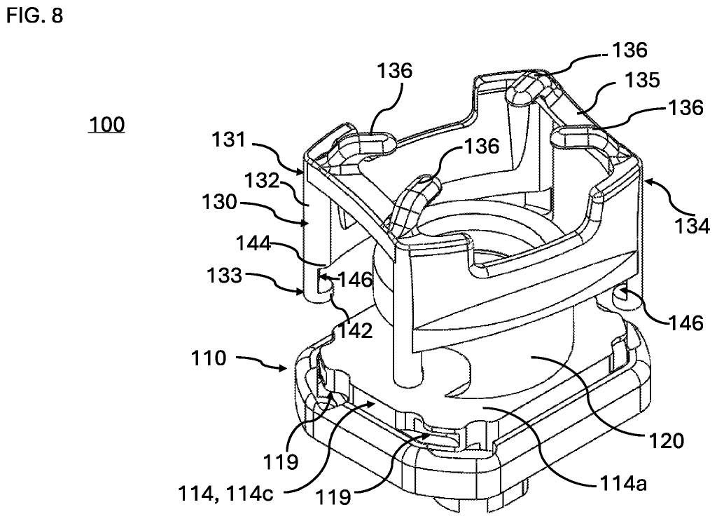

In some embodiments, the retainer 130 includes a plurality of retainer supports 132. In some embodiments, each of the retainer supports 132 extends from a first end 131 that is coupled to a retainer frame 134 to a second end 133 that is configured to be positioned or otherwise seated in one of the plurality of locking seats 118. In some embodiments, the second end 133 of each of the plurality of retainer supports 132 includes a locking structure 140. In some embodiments, the locking structure 140 includes a foot or seat contact portion 142 and an upper lip 144, which together define a notch 146 (FIG. 8).

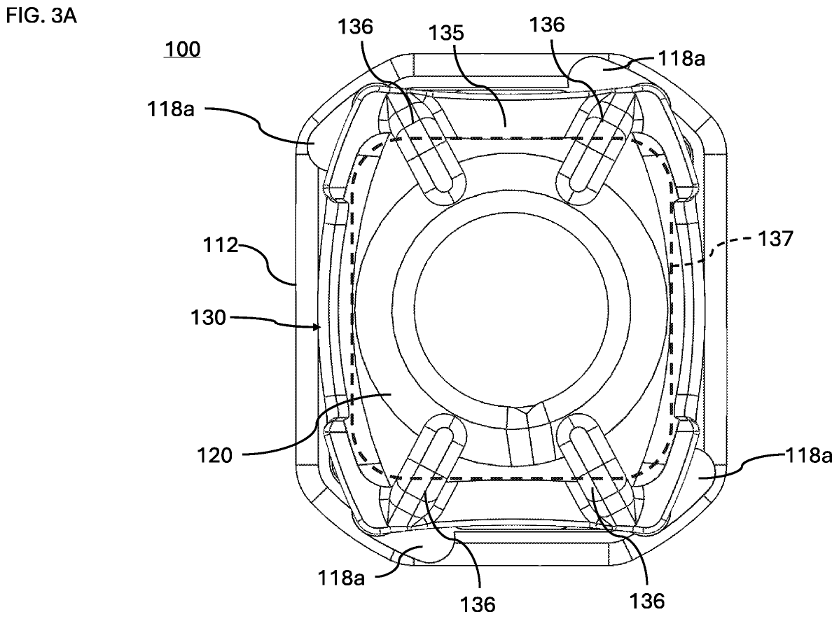

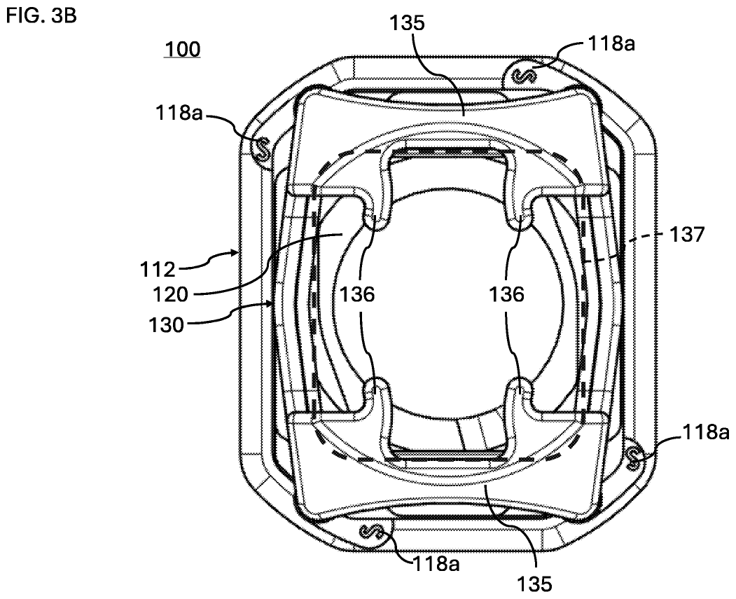

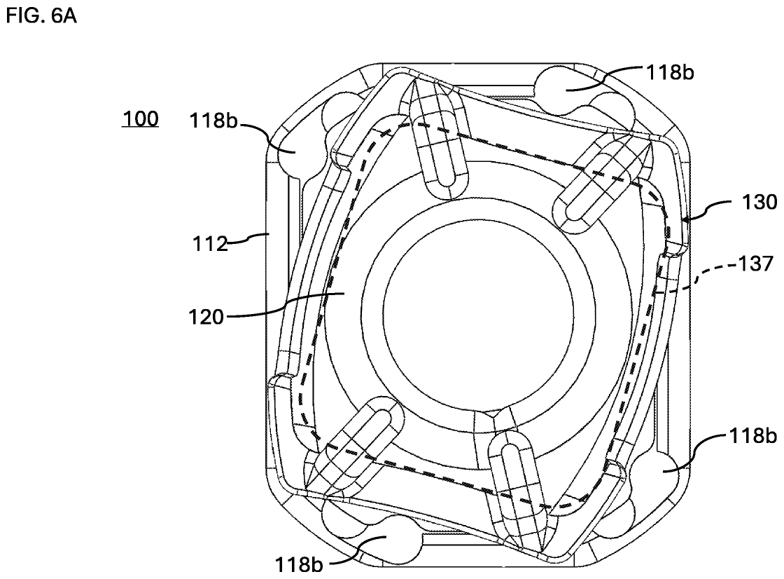

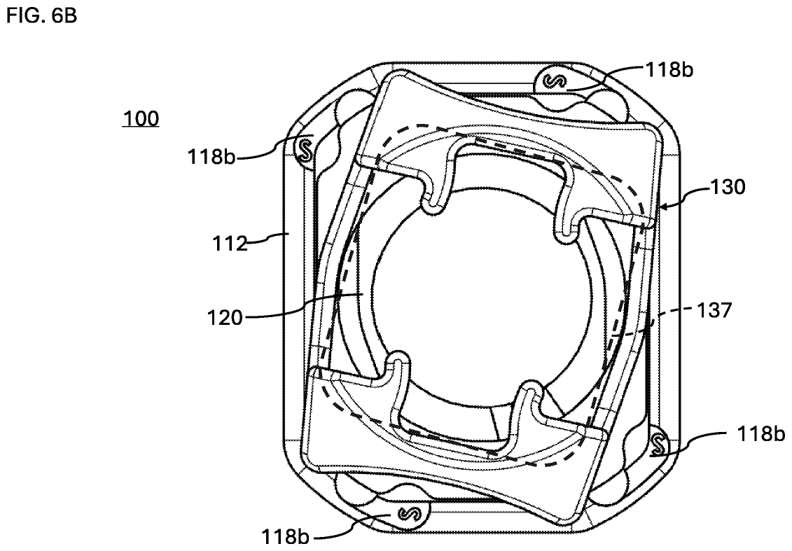

In some embodiments, the retainer frame 134 extends between each of the first ends 131 of the plurality of retainer supports 132 such that the retainer supports 132 and the retainer frame 134 are a monolithic component. In some embodiments, the retainer supports 132 and the retainer frame 134 are formed as a single component. In some embodiments, the retainer supports 132 and the retainer frame 134 define the sides of the retainer 130. In some embodiments, the retainer 130 includes a plurality of retainer members 136 that extend from a top portion 135 of the retainer frame 134. In some embodiments, the top portion 135 of the retainer frame defines a top opening 137 (FIGS. 3 and 6) of the retainer and the plurality of retainer members 136 extend from the top portion and at least partially into or over the top opening 137. In some embodiments, the plurality of retainer supports 132, the retainer frame 134, and the plurality of retainer members 136 form a cage-like structure to retain the electronic device. In some embodiments, the elements of the retainer 130 are formed as a single unitary component.

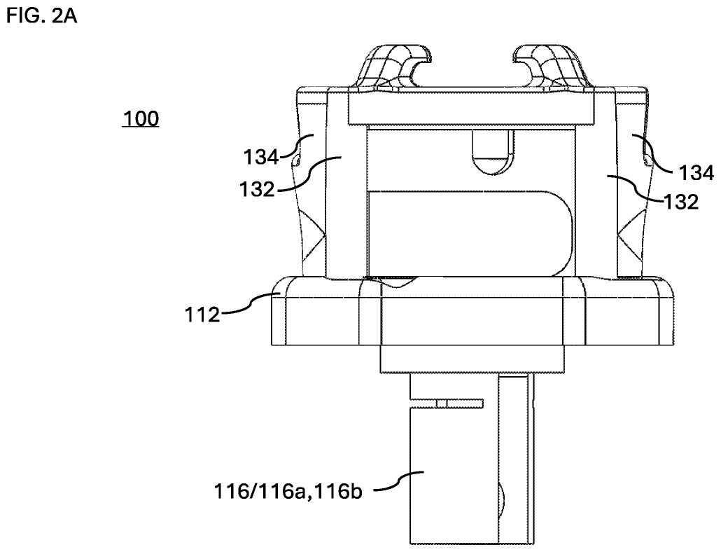

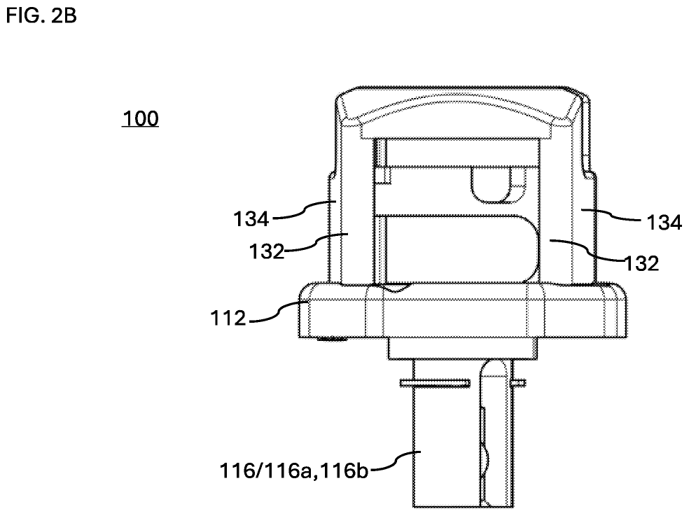

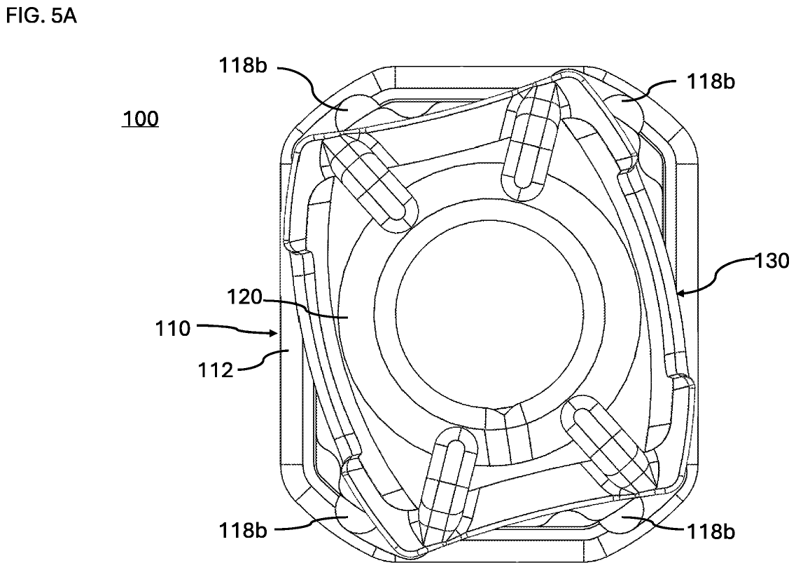

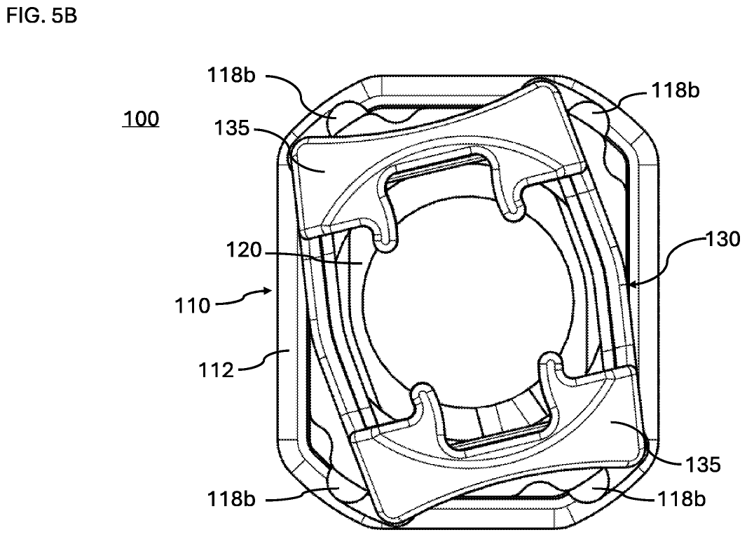

Operation of the security assembly 100 will now be described with general reference to FIGS. 1A-8. Starting at FIGS. 7 and 8, the security assembly 100 is in the unlocked and open position such that the retainer 130 is able to be removed from the base 110. Removal of the retainer 130 from the base 110 enables positioning of the electronic device on the support structure 120 or on the top surface 114a of the support body 114. Once the electronic device is positioned on the support structure 120 or the top surface 114a of the support body 114, the second end 133 of each of the plurality of retainer supports 132 is inserted into the first portion 118a of each of the locking seats 118 as shown in FIGS. 5A, 5B, 6A and 6B. The retainer 130 is then pivoted or otherwise moved such that the locking structure 140 at the second end 133 of each retainer support 132 moves from the first portion 118a of the locking seat 118b to the second portion 118b of the locking seat 118 as shown in FIGS. 3A, 3B, 4A and 4B. When the locking structure 140 is moved to the second portion 118b, the seat contact portion 142 is positioned in the pocket 119 to inhibit the retainer 130 from being pulled away from the base 110 and the notch 146 is dimensioned to receive a portion of the support body 114. The plurality of support portions 116a, 116b are then retracted to lower the support body 114 to move the security assembly 100 to the closed position as shown in FIGS. 1A, 1B, 2A, and 2B. In the closed position, the support body 114 is lowered relative to rim 112 such that the retainer 130 is inhibited from being pivoted relative to the rim 112 or removed from the base 110. In some embodiments, the plurality of support portions 116a, 116b may be locked to inhibit movement of the plurality of support portions 116a, 116b relative to each other and inhibit release of the retainer 130 from the base 110. The security assembly 100 may then be securely attached to a display fixture for secure display of the electronic device during store hours. In some embodiments, the security assembly 100 may be attached to the display fixture via the base support 116. In some embodiments, the security assembly 100 may be attached to the display fixture using one or more fasteners.

In order to remove the electronic device from the security assembly 100, the security assembly 100 is unlocked such that the plurality of support portions 116a, 116b can be extended. In some embodiments, when the security assembly 100 is unlocked, the base support 116 automatically extends. In some embodiments, the base support 116 is biased into the extended position. Extending the plurality of support portions 116a, 116b moves the security assembly 100 into the open position (FIGS. 4A and 4B) such that the top surface 114a of the support body 114 is positioned above the rim 112. The retainer 130 may then be pivoted such that the locking structure 140 of each of the plurality of retainer supports 132 moves from the second portion 118b to the first portion 118a of the locking seat 118 as shown in FIGS. 5A, 5B, 6A, and 6B. Moving the locking structure 140 from the second portion 118b of the locking seat 118 to the first portion 118a of the locking seat 118 removes the seat contact portion 142 from the pocket 119. Once positioned in the first portion 118a, the retainer 130 may be detached from the base 110 and the electronic device may be removed from the support structure 120 as shown in FIGS. 7 and 8. The disclosed embodiments of the security assembly 100 enable easy securing and removal of the electronic device so that displayed merchandise may be securely displayed during store hours and removed from secure display during afterhours. While several of the embodiments have been discussed with regard to securing portable electronic devices, such as smart watches, it should be realized that the security assembly 100 is capable and may be further configured to securely display other items of merchandise in a retail setting.

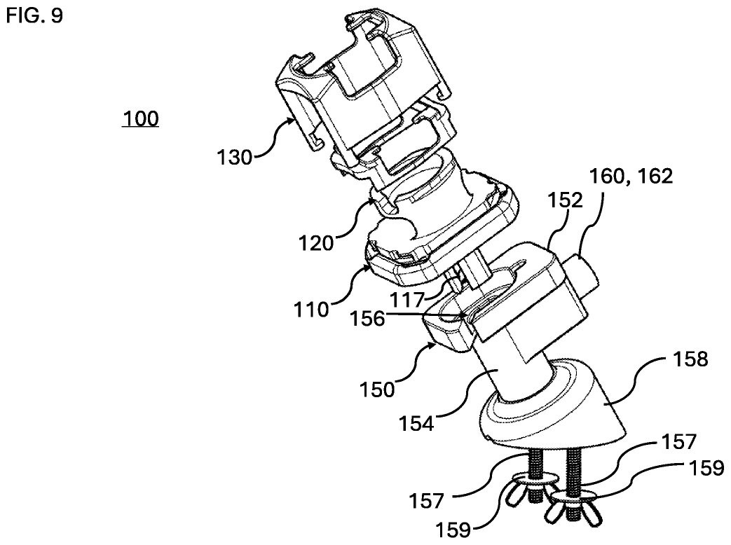

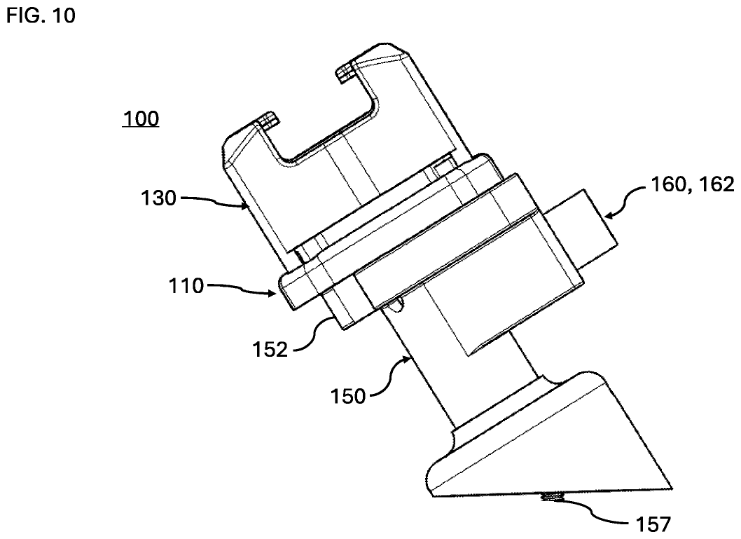

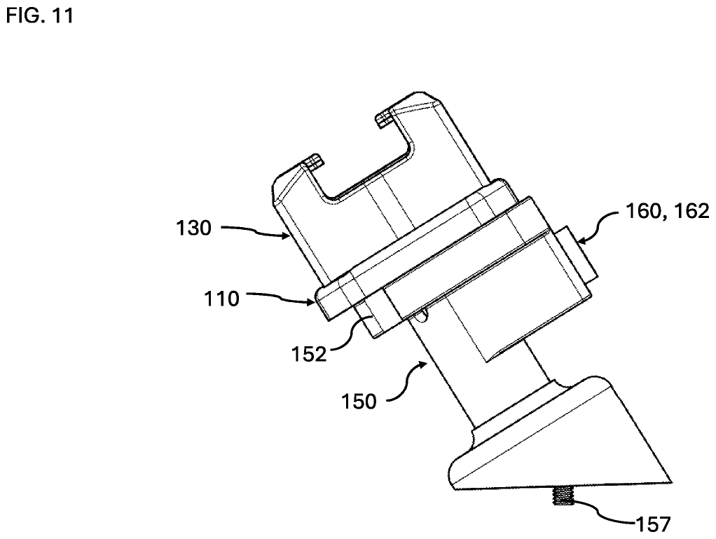

Referring to FIGS. 9-11, in some embodiments, the security device 100 further includes an anchor member 150 configured to facilitate the anchoring or coupling of the security device 100 to a display fixture. In some embodiments, the anchor member 150 includes a body 151 comprising a seat portion 152 defining a base support seat 156 that is dimensioned to at least partially accept the base support 116. In some embodiments, the seat portion further includes a pedestal 154. In some embodiments, the pedestal 154 may be adjustable. In some embodiments, the seat portion 152 further includes a lock including a lock member 162 that is configured to be moved between a locked state and an unlocked state using a key. In some embodiments, the key is a magnetic key. In some embodiments, in the locked position, a portion of the lock member 162 interacts with the base support 116. In some embodiments, one or more of the plurality of support portions 116a, 116b defines a lock member engager 117 (FIGS. 4B and 9) that is configured to cooperate with the lock member 162 to secure the base 110 and retainer 130 to the anchor member 150. In some embodiments, the lock member 162 is biased into the locked position. In some embodiments, a lock engages or contacts the lock member 162 to retract the lock member 162 from the lock member engager 117, which enables separation of the anchor member 150 from the base 110 and retainer 130.

In some embodiments, the pedestal couples to an anchoring portion 158. In some embodiments, the pedestal 154 is movably coupled to the anchoring portion 158. In some embodiments, the pedestal 154 is configured to pivot and/or rotate relative to the anchoring portion 158. In some embodiments, the anchoring portion includes one or more anchors 157 extending from the anchoring portion 158 and configured to engage or cooperate with the display fixture. In some embodiments, One or more securing members 159 are configured to engage the one or more anchors 157 to secure the anchor member 150 to the display fixture. In some embodiments, the one or more anchors 157 include a plurality of surface features that are configured to engage complementary surface features of the one or more securing members 159. In some embodiments, the surface features and complementary surface features are threads. In some embodiments, the one or more securing members 159 are nuts, such as wing nuts. In some embodiments, the one or more anchors 157 are configured to extend between a top surface and a bottom surface of the display fixture and the one or more securing members 159 are configured to be positioned towards the bottom surface of the display fixture.

While the present invention has been particularly shown and described with reference to certain exemplary embodiments, it will be understood by one skilled in the art that various changes in detail may be effected therein without departing from the spirit and scope of the invention that can be supported by the written description and drawings. Further, where exemplary embodiments are described with reference to a certain number of elements, it will be understood that the exemplary embodiments can be practiced utilizing either less than or more than the certain number of elements.

1. A security assembly for secure display of an item of merchandise in a retail setting, comprising:
a base portion including,
a base body including a top surface, a bottom surface, and a plurality of side surfaces, wherein at least two of the plurality of side surfaces define a plurality of pockets,
a rim movably coupled to, and at least partially surrounding, the base body, wherein the rim defines a plurality of locking seats positioned adjacent to each of the plurality of pockets, and
a base support configured to move between an open and closed position; and
a retainer configured to removably coupled to the base portion and including,
a plurality of retainer supports each extending from a first end to a second end, and
a retainer frame that is coupled to each second end of the plurality of retainer supports and defining an opening positioned over the top surface of the base body when the retainer is couped to the base portion,
wherein in the open position, the retainer is removable from the base portion, and
wherein in the closed position, the first end of each of the plurality of base supports is configured to cooperate with one of the plurality of locking seats and one of the plurality of pockets to inhibit separation of the retainer from the base portion.

2. The security assembly of claim 1, wherein in the open position, the plurality of side surfaces of the base body are positioned above the rim, and wherein in the closed position, the plurality of side surfaces are positioned below the rim such that the rim inhibits movement of the first end relative to the one of the plurality of locking seats and the one of the plurality of pockets.

3. The security assembly of claim 1, wherein the base support comprises a first support portion and a second support portion that are configured to be moved relative to each other to move the base body relative to the rim.

4. The security assembly of claim 1, wherein the plurality of retainer supports and the retainer frame are formed as a single unitary component.

5. The security assembly of claim 1, wherein the first end of each of the plurality of retainer supports includes a locking structure comprising a notch defined by a seat contact portion and an upper lip.

6. The security assembly of claim 5, wherein, in the closed position, the seat contact portion is configured to cooperate with one of the plurality of locking seats and one of the plurality of pockets and the notch is dimensioned to receive a portion of the base body.

7. The security assembly of claim 1, wherein the base portion includes a support structure positioned on the top surface of the base body and configured to aid in proper positioning of an item of merchandise to be secured between the base portion and the retainer.

8. A security assembly for secure display an item of merchandise in a retail setting, comprising:
a base body including a top surface, a bottom surface, and a plurality of side surfaces, wherein a plurality of pockets are defined in the plurality of side surfaces;
a rim movably coupled to, and at least partially surrounding, the base body, wherein the rim defines a plurality of locking seats positioned adjacent to each of the plurality of pockets;
a base support configured to move between an open and closed position; and
a retainer configured to removably coupled to the base portion,
wherein in the open position, the retainer is removable from the base body, and
wherein in the closed position, the retainer is configured to cooperate with one of the plurality of locking seats and one of the plurality of pockets to inhibit separation of the retainer from the base portion.

9. The security assembly of claim 8, wherein in the open position, the plurality of side surfaces of the base body are positioned above the rim, and wherein in the closed position, the plurality of side surfaces are positioned below the rim such that the rim inhibits movement of the retainer relative to the one of the plurality of locking seats and the one of the plurality of pockets.

10. The security assembly of claim 8, further comprising a base support comprises a first support portion and a second support portion that are configured to be moved relative to each other to move the base body relative to the rim.

11. The security assembly of claim 9, wherein the retainer includes a plurality of locking structures each comprising a notch defined by a seat contact portion and an upper lip.

12. The security assembly of claim 11, wherein in the closed position, the seat contact portion is configured to cooperate with one of the plurality of locking seats and one of the plurality of pockets and the notch is dimensioned to receive a portion of the base body.

13. The security assembly of claim 12, wherein, in the open position, the seat contact portion of each locking structure is configured to move within the one of the plurality of locking seats and out of the one of the plurality of pockets to enable separation of the retainer from the base portion.

14. The security assembly of claim 8, wherein the base body includes a support structure positioned on the top surface of the base body and configured to aid in proper positioning of the item of merchandise for securing between the base portion and the retainer.

15. A method of manufacturing a security assembly for secure display of an item of merchandise in a retail setting, comprising:
structuring a base portion to include,
a base body including a top surface, a bottom surface, and a plurality of side surfaces that define a plurality of pockets,
a rim at least partially surrounding the base body and defining a plurality of locking seats positioned adjacent to each of the plurality of pockets, and
a base support configured to move between an open and closed position;
structuring a retainer to removably couple to the base portion; and
structuring the retainer to cooperate with one of the plurality of locking seats and one of the plurality of pockets to inhibit separation of the retainer from the base portion when in the closed position.

16. The method of claim 15, further comprising structuring the plurality of side surfaces of the base body to be positioned above the rim when in the open position, and structuring at least a portion of the plurality of side surfaces to be positioned below the rim when in the closed position, such that the rim inhibits movement of the retainer relative to the one of the plurality of locking seats and the one of the plurality of pockets.

17. The method of claim 15, further comprising structuring the base support to comprises a first support portion and a second support portion that are configured to be moved relative to each other to move the base body relative to the rim.

18. The method of claim 16, further comprising structuring the retainer to include a plurality of locking structures that each comprise a notch defined by a seat contact portion and an upper lip.

19. The method of claim 18, further comprising structuring each seat contact portion to move within the one of the plurality of locking seats and out of the one of the plurality of pockets to enable separation of the retainer from the base portion when in the open position.

20. The method according to claim 19, further comprising structuring the seat contact portion to cooperate with one of the plurality of locking seats and one of the plurality of pockets and dimensioning the notch to receive a portion of the base body when in the closed position.
